(19) United States
(12) Patent Application Publication
(10) Pub. No.: US 2006/0190611 A1
(43) Pub. Date: Aug. 24, 2006

(54) Access management method between plural devices constituted by hierarchical relation, management computer, and computer system

(75) Inventors: Fumi Miyazaki, Kawasaki (JP); Yuichi Taguchi, Sagamihara (JP); Masayuki Yamamoto, Sagamihara (JP); Yasunori Kaneda, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/097,037

(22) Filed: Apr. 1, 2005

(30) Foreign Application Priority Data
Feb. 21, 2005 (JP) 2005-043368

(51) Int. Cl. G06F 15/16

(52) U.S. Cl. 709/229

(57) ABSTRACT

In a computer system that includes plural host computers and plural data storage apparatuses (storage systems) and performs, in particular, virtualization of a data storage area, unless zoning is performed correctly to activate a zone between a data storage apparatus holding a virtualized data storage area and a device holding a data storage area storing actual data, the storage area storing actual data cannot be used from the host computers. The present invention provides a mechanism for grasping a relation between the virtualized data storage area and the data storage area storing actual data, configuring a zone between data storage apparatuses holding the data storage areas as a special zone, and always activating the special zone at the time of zoning configuration. The invention further provides a mechanism for grasping a relation between the virtualized data storage area and the data storage area storing actual data, associating a zone for connecting the host computers and a first-tier data storage apparatus and a zone for connecting the first-tier data storage apparatus and a second-tier data storage apparatus, and activating a second zone according to switching activating first zone.

### CROSS-REFERENCES TO RELATED APPLICATIONS

This application relates to and claims priority from Japanese Patent Application No. P2005-043368 filed on Feb. 21, 2005, the entire disclosure of which is incorporated herein by reference.

### BACKGROUND

The present invention relates to a computer system and a method for computer system management, and in particular to a method for access management in a hierarchical computer system.

In the field of a storage area network (SAN) in which plural host computers and plural data storage apparatuses are connected by a fabric switches, a technique for access control called zoning is disclosed (see U.S. Pat. No. 6,765,919). This technique groups data storage area by a specific host computer can access, by an FC switch in order to prevent mutual interference in which the plural host computers, which are connected to the SAN and in which plural operating systems are operating, share the same data storage area of a data storage apparatus (in order to realize exclusive access).

United States Patent Application Publication No. 2003-0221077 discloses a computer system in which a host computer and a first data storage apparatus are connected via a communication path in a SAN or the like and the first data storage apparatus and a second data storage apparatus are connected hierarchically via a second communication path. In the processing performed by the computer system disclosed in United States Patent Application Publication No. 2003-0221077, the first data storage apparatus receives a first data input/output request from the host computer via the first communication path and, when the first data storage apparatus judges that the first data input/output request is not a request to which the first data storage apparatus should excute, the first data storage apparatus transmits a second data input/output request to the second data storage apparatus via the second communication path, and the second data storage apparatus receives the second data input/output request to execute the second data input/output request.

### SUMMARY

The inventors of the present invention has found that, when the access control according to the zoning is activated in the computer system in which devices such as data storage apparatuses are configured hierarchically as in the background art, it is necessary to grasp a correspondence relation between plural zones and a hierarchy of the devices.

FIG. 20A shows a form of a computer system utilizing zoning in a computer system in which devices are configured hierarchically. Zoning is realized exclusive access between host computer and data storage apparatus, by grouping FC ports of apparatuses connected to a fibre channel switch (hereinafter referred to as FC switch) into groups called zones and permitting mutual communication among the FC ports belonging to the zones. Specifying for members belonging to the zones (grouping) is defined by a unit of an FC port number of the FC switch or by a unit of a World Wide Name (WWN: an identification number uniquely identifying the FC port) of a data storage apparatus or a host computer that can access the data storage apparatus. When a member of a zone is designated with an FC port number of the FC switch, a device connected to the FC port is treated as a member of the zone. When a member of a zone is designated with a WWN, a device having the FC port designated WWN is treated as a member regardless of a connection relation of the member.

In a configuration of the computer system shown in FIG. 20A, a data storage apparatus A 100 and a data storage apparatus B 200 are connected hierarchically. The data storage apparatus A 100 provides a host computer A 301 with a data storage area 262 of the data storage apparatus B 200 as if the data storage area 262 is a data storage area (a virtualized data storage area 162 in FIG. 2) of the data storage apparatus A 100. In this case, a zone 1 is defined for mutual communication between the host computer A 301 and the data storage apparatus A 100 and a zone 2 is defined for mutual communication between the data storage apparatus A 100 and the data storage apparatus B 200. Such definitions of the zones indicate that only the host computer A 301 can access the virtualized data storage area 162 of the data storage apparatus A 100 and only the virtualized data storage area 162 of the data storage apparatus A 100 can access the data storage area 262 of the data storage apparatus B 200. The FC switch manages information on this zoning control as a zoning configuration table 526. A set of zones activated by the zoning (the zone 1 and the zone 2 in the case of FIG. 20A) will be hereinafter referred to as a zone set. A zone to be activated is determined by activating or inactivating the zone set. According to the patent documents above, it is possible to add all zones as the member of the zone set, which are desired to be activated by the zoning, in one zone set and set active/inactive to the zone set.

Thus, in the computer system shown in FIG. 20A, when a host computer B for performing processing different from the processing of the host computer A 301 is installed anew and the processing is switched according to a time frame (e.g., when a host computer B 302 for performing backup concentrically at night or the like is installed anew), it is necessary to switch a host computer accessing the data storage apparatus A 100 from the host computer A 301 to the host computer B 302 according to a time frame. Therefore, first, an administrator (e.g., a backup administrator) of the host computer B 302 defines a zone 3 shown in FIG. 20B in order to cause the host computer B 302 and the data storage apparatus A 100 to perform exclusive access. In this case, when the administrator of the host computer B 302 does not know that the data storage apparatus A 100 is connected to the data storage apparatus B 200 hierarchically and actual data is stored in the data storage apparatus B 200, it is assumed that the administrator defines and activates a zoneset B including only the zone 3 as a component (i.e., not including the zone 2). Then, the host computer B 302 is only permitted to access the virtualized data storage area 162 of the data storage apparatus A 100 and cannot access the data storage area 262 of the data storage apparatus B200 in which the actual data is stored. Therefore, processing requested by the host computer B 302 cannot be realized. In this way, it is impossible to grasp a correspondence relation between a zone and a hierarchy of devices and it is difficult to perform appropriate zoning taking into account zones which contains a device that provides a virtualized data storage area and a device that holds a data storage area storing actual data.

The situation described above occurs, in particular, when a computer system, which is constituted by plural host computers and plural data storage apparatuses and specifically provides virtualization functions of a data storage area, is managed by two or more administrators individually. In other words, when each administrators manages for each host computer, FC switch, and data storage apparatus individually, if an administrator of the FC switch is not aware of a correspondence between a hierarchical relation among data storage apparatuses and a path from a host computer to a resource storing data used by the host computer, it is likely that the host computer cannot use the data depending on configuration for a zoning.

In order to solve at least any one of the problems, an access management method as an embodiment of the invention is an access management method for a computer system including: a host computer, a virtualized device that provides a data storage area recognizable by the host computer; a storage device in which data used by the host computer is stored; and a fabric connected to the host computer, the virtualized device, and the storage device. In the computer system, plural access permission paths in the fabric are defined, the plural access permission paths are configured in association with one another, and the fabric performs access control that allows the virtualized device to read out data from and write data in the storage device when the virtualized device received the read/write request from the host computer. With this configuration, access management taking into account a system configuration of the computer system is provided.

The fabric is, for example, a system having a single fibre channel switch or two or more fibre channel switches that are connected to each other such that data is transmitted physically between two ports of the switches. The devices as well as the devices and the host computer are connected to the devices via the fabric.

Here, the access permission path is, for example, a data communication path between the host computer and the devices connected to the host computer via the fabric or a path among the devices, which allow to communicate with each other. In addition, when a part of the path is a combination of the ports in the fabric, an access permission path is a zone permitting data communication between the ports, and the zone is configured in the fabric.

As another example, when plural access permission paths are defined in a path for a certain host computer to use data stored in the storage device, an access permission path between the virtualized device and the storage device is designated as a specific permission path. When an access permission path between the host computer and the virtualized device is set, the access permission path is set together with the designated specific permission path. With this configuration, access management based on a hierarchy of devices in a virtualized environment is provided.

### BRIEF DESCRIPTION OF THE DRAWINGS

In the accompanying drawings:

FIG. 1 is a diagram showing an example of a configuration of a computer system in which a method for zoning management in a first embodiment of the invention is provided;

FIG. 2A is a diagram showing an example of a data storage area management table;

FIG. 2B is a diagram showing an example of a data storage apparatus port management table;

FIG. 2C is a diagram showing an example of a host computer port management table;

FIG. 3A is a diagram showing an example of a link information management table;

FIG. 3B is a diagram showing an example of a zone definition table;

FIG. 3C is a diagram showing an example of a zoning configuration table;

FIG. 4 is a diagram showing an example of a special zone management table;

FIG. 5 is a diagram showing an example of a zone definition configuration screen;

FIG. 6 is a conceptual diagram of a method for zoning management in the first embodiment;

FIG. 7A is a diagram showing an example of a zoning configuration screen;

FIG. 7B is a diagram showing an example of a zoning configuration warning screen;

FIG. 7C is a diagram showing an example of a result of a zoning configuration screen to which a zoning configuration based on the first embodiment is applied;

FIG. 8 is a diagram showing a processing flow of a special zone detection program;

FIG. 9 is a diagram showing a processing flow of a special zone set activation program by external port;

FIG. 10 is a diagram showing an example of a configuration of a computer system in which a method for zoning management in a second embodiment of the invention is provided;

FIG. 11 is a conceptual diagram of a method for zoning management in the second embodiment;

FIG. 12A is a diagram showing an example of a data storage area management table of a data storage apparatus A;

FIG. 12B is a diagram showing an example of a data storage area management table of a data storage apparatus B;

FIG. 13A is a diagram showing a zone definition table;

FIG. 13B is a diagram showing a zone mapping information table;

FIG. 14 is a diagram showing a processing flow of a mapping zone detection program;

FIG. 15 is a diagram showing a processing flow of a zone set activation program by storage hierarchy;

FIG. 16 is a diagram showing an example of a configuration of a computer system in which a method for zoning management in a third embodiment of the invention is provided;

FIG. 17 is a conceptual diagram of the method for zoning management in the third embodiment;

FIG. 18 is a diagram showing a processing flow of a special zone configuration program;

FIG. 19 is a diagram showing a processing flow of a zone set activation program; and

FIG. 20A and 20B are diagrams showing an example for explaining forms of zoning management in computer system.

### DESCRIPTION OF THE PREFERRED EMBODIMENTS

Embodiments of the present invention will be hereinafter explained in detail with reference to the accompanying drawings.

In a first embodiment of the invention, a computer system includes a host computer, a first data storage apparatus connected to the host computer via an FC switch, and a second data storage apparatus hierarchically connected to the first data storage apparatus via an FC switch. The computer system detects an FC port for connecting with the second data storage apparatus in the first data storage apparatus, detects a zone to which the FC port is a member, and adds the detected zone to the member of a zone set.

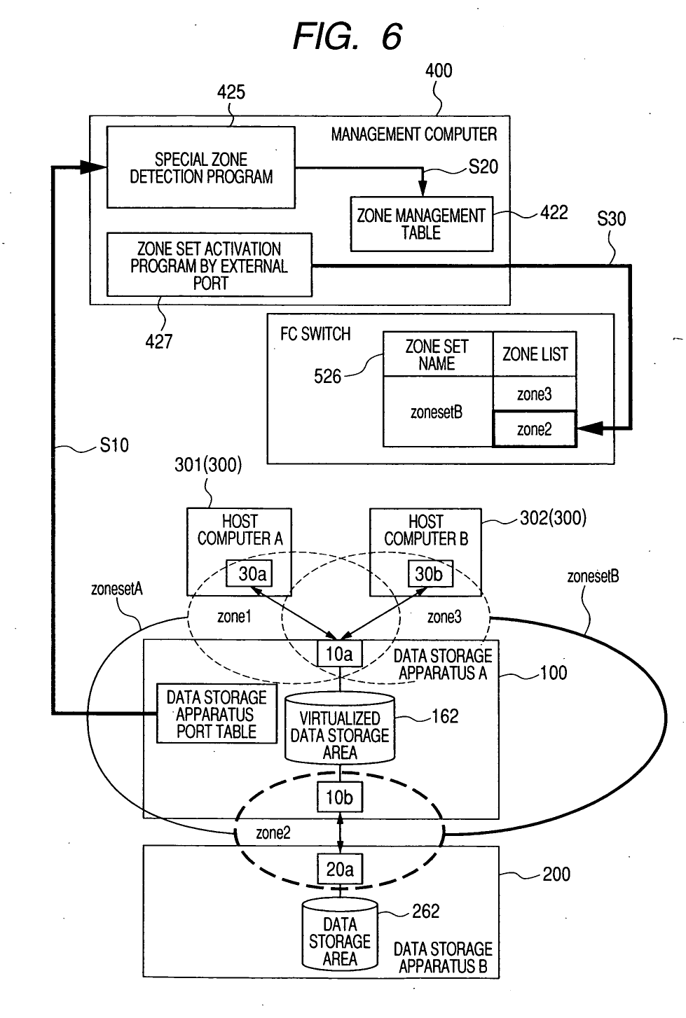

FIG. 6 is a diagram schematically showing processing in the computer system in the first embodiment. In FIG. 6, two host computers 300 (a host computer A 301 and a host computer B 302) and a data storage apparatus A 100 are connected via an FC switch and the data storage apparatus A 100 and a data storage apparatus B 200 are connected via an FC switch. The data storage apparatus A 100 provides the host computers 300 with a data storage area 262 of the data storage apparatus B 200 as if the data storage area 262 is a data storage area (a virtualized data storage area 162) of the data storage apparatus A 100. The computer system also includes a management computer 400 in addition to the host computers 300, the data storage apparatus A 100, and the data storage apparatus B 200. The management computer 400 performs management and control for the FC switches for connecting the host computers 300 and the data storage apparatus A 100 as well as the data storage apparatus A 100 and the data storage apparatus B 200. The management computer 400 holds a special zone management table 422, a special zone detection program 425 for detecting a zone for permitting data communication between the data storage apparatuses A 100 and B 200, and a zone set activation program by external port 427 for adding the detected zone as the member of a zone set. The management computer is capable of executing the programs.

In the following explanation, a method of carrying out zone configuration will be explained. The method of carrying out zone configuration is performed when a zone 1 and a zone 2 are configured as active zones as shown in FIG. 6 and a host computer using the virtualized data storage area 162 is changed from the host computer A 301 to the host computer B 302.

[Outline of a Definition of a Special Zone]

The special zone detection program 425 judges whether an FC port 10b of the data storage apparatus A 100 connected to the data storage apparatus B 200 is included in FC ports, which are members of a zone, with reference to a data storage apparatus port management table of the data storage apparatus A 100 (S 10). Next, when the corresponding FC port is present in the zone, the special zone detection program 425 sets a flag in the zone (S20: setting information of the flag is held in the special zone management table 422). In the configuration in FIG. 6, the zone 2 is set as a special zone.

[Outline of Configuration for Zoning]

When changing in a configuration of zoning, the zone set activation program by external port 427 judges whether a zone as an external connection zone, in which a flag is set, belongs to a zone set to be defined by an administrator and, if the zone does not belong to the zone set, the zone with the flag is added to the zone set. The zone set activation program by external port 427 sends from the management computer 400 to an FC switch 500 an instruction set in the zone set including the zone with the flag. For example, in the case of the configuration in FIG. 6, the zone set activation program by external port 427 includes the zone 2 in a zone set B and requests the FC switch 500 to configure zoning (when the request is received, the FC switch 500 updates a zoning configuration table 526) (S30).

The zone set activation program by external port 427 carries out the processing described above in the management computer 400, whereby the zone 2 as the zone with the flag is added as the member of the zone set. Thus, it is possible to guarantee mutual communication between the data storage apparatus A 100 and the data storage apparatus B 200 regardless of a change of a zoning configuration between the host computers 300 and the data storage apparatus A 100.

System Configuration

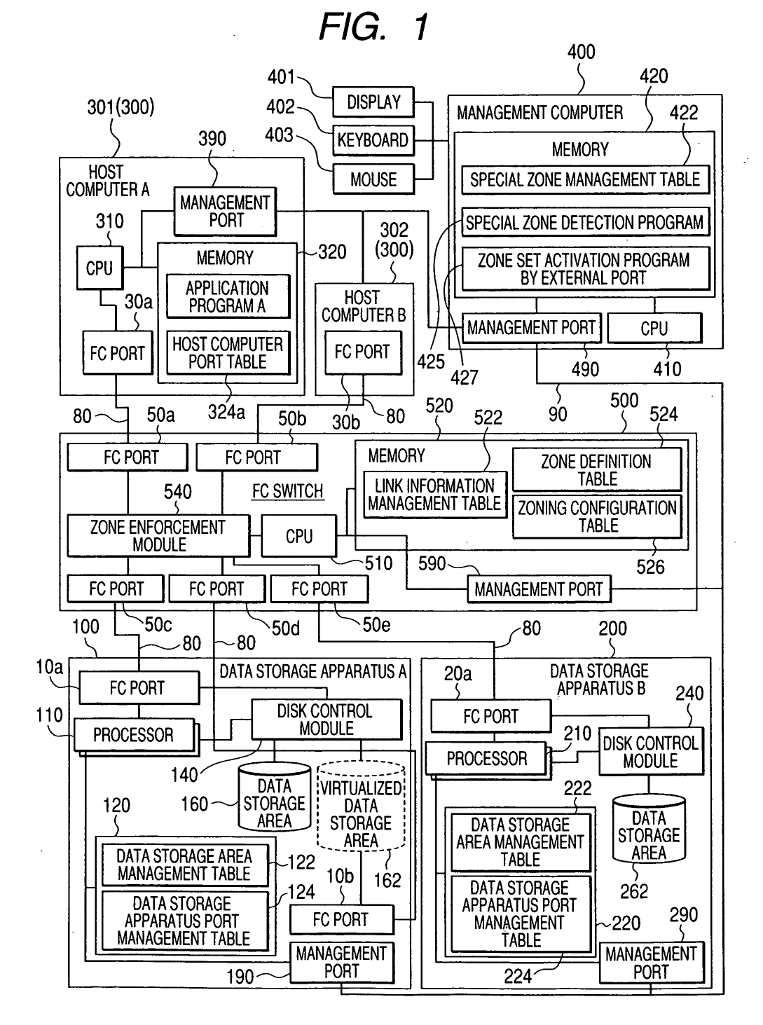

FIG. 1 shows a configuration of a computer system of the first embodiment. The two host computers 300 (the host computer A 301 and the host computer B 302) are connected to the data storage apparatus A 100 via the FC switch 500 and the data storage apparatus A 100 is connected to the data storage apparatus B 200 via the FC switch 500. In addition, the management computer 400 is prepared to connect the host computers 300, the FC switch 500, the data storage apparatus A 100, and the data storage apparatus B 200 via a management network 90. An IP network is used as the management network 90. The management network 90 is not restricted by protocols such as Fibre Channel and IP. The numbers of host computers, FC switches, and data storage apparatuses are not limited to those in this configuration.

Host Computer 300 (Common to the Host Computer A 301 and the Host Computer B 302)

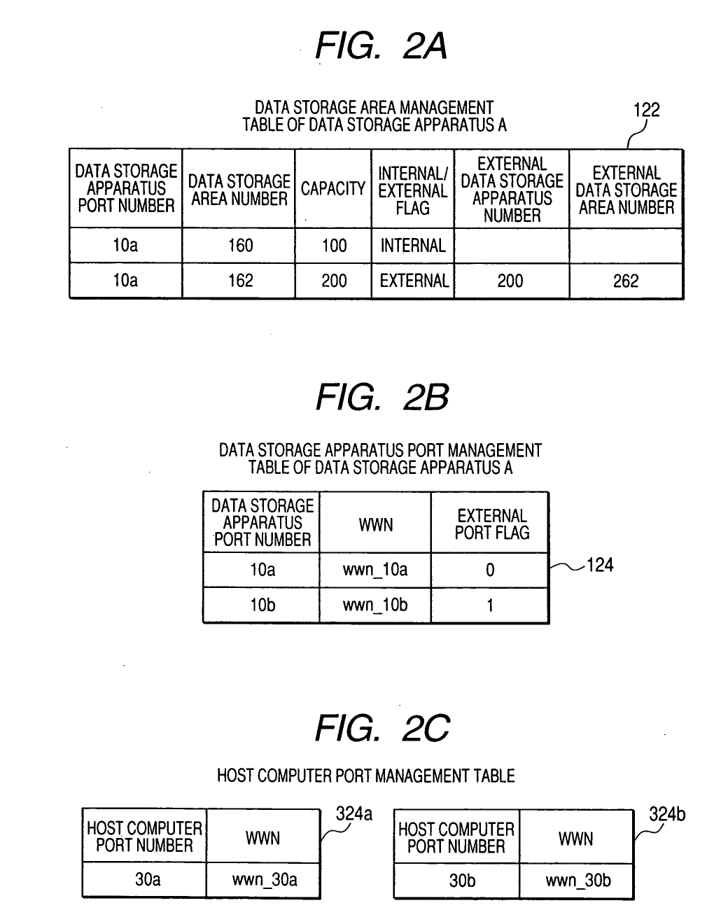

The host computer 300 includes a CPU 310 for executing a program, a memory 320 for holding the program and data to be executed by the CPU 310, and an FC port 30a for connecting the host computer 300 to the data storage apparatus A 100 via the FC switch 500. A host computer port management table 324 for holding information on FC ports of host computers is provided in the memory 320. As shown in FIG. 2C, the host computer port management table 324 has, for each FC port, a host computer port number and a WWN serving as an identification number for uniquely identifying a port. In this embodiment, for simplification of explanation, the numbers in FIG. 1 are used for the host computer port number and host computer port numbers added with “wwn_” are used for the WWN. The programs and the tables are stored in an external storage medium such as a hard disk and are loaded them on the memory 320 when the host computer 300 runs. The CPU 310 loads and executes the programs and the tables from the memory.

Data Storage Apparatus A 100

The data storage apparatus A 100 (a storage system) has an FC port 10a for connecting the data storage apparatus A 100 to the host computer 300 and an FC port 10b for connecting the data storage apparatus A 100 to the data storage apparatus B 200. The data storage apparatus A 100 is connected to an FC switch and the external data storage apparatus. The data storage apparatus A 100 includes a data storage area 160 (an actual data storage area) that is internal data storage area in the data storage apparatus A 100 and a virtualized data storage area 162 that shows a data storage area in the data storage apparatus B 200 as if the data storage area is a data storage area of the data storage apparatus A 100. In other words, the virtualized data storage area 162 is a data storage area that is provided to the host computer 300 by the data storage apparatus A serving as a virtualized device. Note that the data storage area 160 is provided by RAID(Redundant Arrays of Inexpensive Disks) configuration used of plural disk drives in the data storage apparatus A 100.

Further, the data storage apparatus A 100 includes a disk control module 140 for controlling data storage areas, a processor 110 (or plural processors 110) that performs processing for a request from the host computer 300 and control for the disk control module 140, and a control memory 120 that stores programs to be used by the processor 110 and the disk control module 140 and tables to be required for execution of the programs. When a request to access the virtualized data storage area 162 (a read request or a write request) is received from the host computer 300, the processor 110 creates a request to access the data storage apparatus B 200 and sends the request to the data storage apparatus B 200 via the FC port 10b.

The data storage apparatus A 100 also includes a management port 190 to connect with the management computer 400 via the management network 90. The control memory 120 includes a data storage area management table 122 for managing data storage areas and a data storage apparatus port management table 124 for managing port information of data storage apparatuses. The programs and the tables are stored in a recording medium such as a hard disk and are loaded them on the memory 120 when the data storage apparatus 300 runs, and executed by the processor 110, whereby functions of the programs and the tables are realized.

Data Storage Apparatus B 200

The data storage apparatus B 200 (a storage system) is an example of a storage device. As in the data storage apparatus A 100, the data storage apparatus B 200 includes a processor 210 that performs control for input from and output to the outside and execution of programs and a disk control module 240 that controls the data storage area 240 storing data. Similarly, the data storage apparatus B 200 includes a control memory 220 that stores the data storage area management table 222 and the data storage apparatus port management table 224 that are read out and referred to by the processor 210. The data storage apparatus B 200 has an FC port 20a that is connected to the data storage apparatus A 100 via the FC port 50e.

[Data Storage Area Management Table 122]

As shown in FIG. 2A, the storage area management table 122 has, for each data storage area, a data storage apparatus port number assigned to the data storage area, a data storage area number, a capacity of the data storage area, an internal/external flag representing presence of a data storage area storing actual data (the flag is “internal” when the data storage area is in the data storage apparatus and the flag is “external” when the data storage area is in another data storage apparatus), an external data storage apparatus number indicating another data storage apparatus when the internal/external flag is “external”, and an external data storage area number of another data storage apparatus. In FIG. 2A, the internal/external flag is “internal” for a data storage area with the data storage area number 160. This indicates that the data storage area 160 is a data storage area prepared by the data storage apparatus A 100. In addition, the internal/external flag is “external” for a data storage area with the data storage area number 162. This indicates that the data storage area 162 is a virtualized data storage area.

It is seen from contents described in the columns of the external data storage apparatus number and the external data storage area number that the data storage area storing actual data is the data storage area 262 of the data storage apparatus B 200. In this embodiment, for simplification of explanation, the numbers in FIG. 1 are used as the data storage apparatus number and the data storage area number.

Incidentally, in the explanation of this embodiment, the data storage apparatus does not use a function (LUN security or LUN masking) with which the disk control module 140 processes only a request from the host computer 300 having a specific WWN which data storage apparatus accepts. When such a technique is used, it is necessary to provide a setting changing program (not shown) in the management computer 400.This setting changing program is a program which performs to permit access to the virtualized data storage area from another host computer (in this case, the host computer 302) when the zoning configuration changes.

[Data Storage Apparatus Port Management Table 124]

As shown in FIG. 2B, the data storage apparatus port management table 124 has, for each FC port, a data storage apparatus port number, a WWN serving as an identification number for uniquely identifying the FC port, and an external port flag. When the external port flag is “0”, the external port flag indicates that the FC port has a role of receiving a read/write request from a host computer. When the external port flag is “1”, the external port flag indicates that a processor of the data storage apparatus A 100, which has received a read/write request from a host computer, has a role of creating and issuing a read/write request to a second-tier data storage area (in the case of this embodiment, the data storage area 262). An FC port with the external port flag “1” is hereinafter referred to as an external port. In this embodiment, for simplification of explanation, the numbers in FIG. 1 are used for the data storage apparatus port number and data storage apparatus port numbers added with “wwn” are used for the WWN.

As setting of the external port flag, the management computer 400 performs setting processing according to an input by an administrator when the data storage apparatus A 100 and another data storage apparatus are connected physically. As the setting processing, first, the management computer 400 acquires the data storage apparatus port management table 124 from the data storage apparatus A 100 via a management port 490 and displays a list of FC ports on a display 401. When the administrator selects FC ports using a keyboard 402 and a mouse 403, the management computer 400 requests the data storage apparatus A 100 to change a column of external port flag of FC port selected by the administrator. When the request is received from the management computer 400, the data storage apparatus A 100 updates the data storage apparatus port management table 124 in accordance with the request from the management computer 400.

The data storage area management table and the data storage apparatus port management table of the data storage apparatus A 100 have been explained. Since a data storage area management table and a data storage apparatus port management table of the data storage apparatus B 200 are the same as those in the data storage apparatus A 100, explanations thereof are omitted.

FC Switch 500

The FC switch 500 includes five FC ports 50a to 50e for connecting the FC switch 500 to host computers and data storage apparatuses, a zone enforcement module 540, a CPU 510, a memory 520, and a management port 590 for connecting the FC switch 500 to the management computer 400.

The memory 520 has a link information management table 522 for providing a WWN of an FC port of a device to which the FC switch 500 is connected, a zone definition table 524 for managing a defined zone, and the zoning configuration table 526 for managing definition of zone sets and an information of an active zone set. The zone enforcement module 540 controls data transfer among the FC ports in accordance with the zone definition table 524 and the zoning configuration table 526. The CPU 510 controls the zone enforcement module 540. The tables are stored in a recording medium such as a hard disk, loaded on the memory 520 when the FC switch 500 runs, and executed by the CPU 510, whereby functions of the tables are realized. In this embodiment, the host computer 300 and the data storage apparatus A 100 as well as the data storage apparatus A 100 and the data storage apparatus B 200 are connected by one FC switch 500. However, two FC switches connected to each other may be constituted as one fabric.

[Link Information Management Table 522]

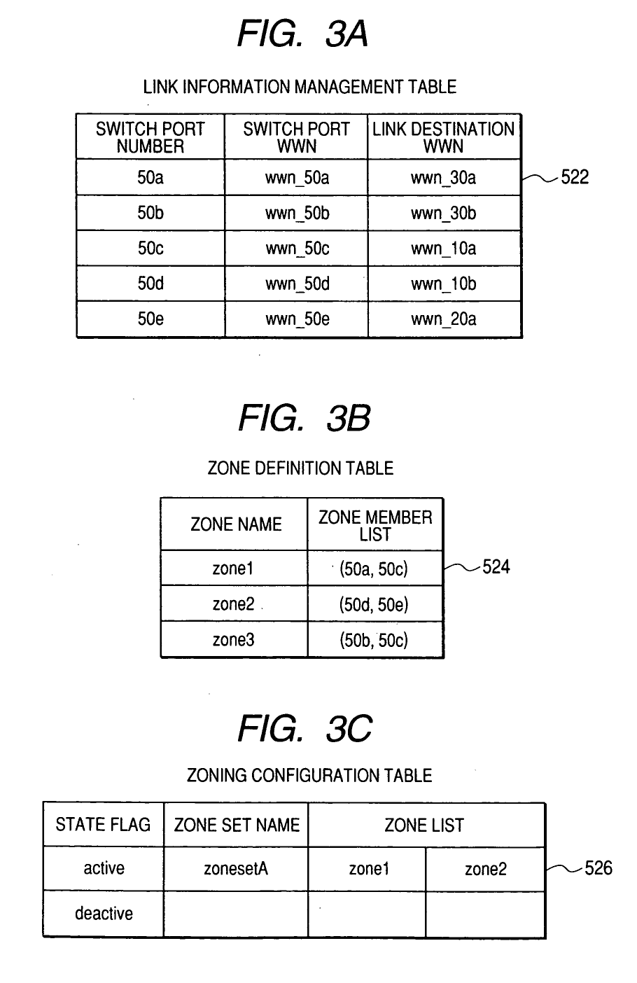

FIG. 3A shows an example of the link information management table 522. The link information management table 522 has, for each FC port, a switch port number, a WWN serving as an identification number for uniquely identifying an FC port, and a link destination WWN indicating a WWN of an FC port of apparatus connected to the FC switch 500. In a form adopted in this embodiment, there are five FC ports 50a to 50e and all the FC ports are connected to other apparatuses. However, the number of FC ports is not limited to this. When no apparatus is physically connected to an FC port, a column of the link destination WWN is left blank. In this embodiment, for simplification of explanation, the numbers in FIG. 1 are used for the switch port number and switch port numbers added with “wwn_” are used for the WWN.

[Zone Definition Table 524]

FIG. 3B shows an example of the zone definition table 524. The zone definition table 524 is a table for a zone defined in the FC switch 500 and has, for each zone, a zone name and a member list included in the zone. In this embodiment, an FC port number of the FC switch 400 is selected as a member.

For example, the FC ports 50a and 50c are zone members of the zone “zone 1”. Data transmission between the FC ports in the same zone is permitted. In other words, a read/write request from the FC port 30a of the host computer A 301 is controlled such that the FC port 10a of the Data storage apparatus A 100 can receive the read/write request. When a zone definition table 524 is received update request from the management computer 400, the CPU 510 of the FC switch 500 judges whether a zone included in the request has already been defined. If the zone has already been defined, the CPU 510 updates the zone of the zone definition table 524. If the zone has not been defined, the CPU 510 adds a zone name and a zone member included in the request to the zone definition table 524 and returns an update completion notice to the management computer 400.

[Zoning Configuration Table 526]

FIG. 3C shows an example of the zoning configuration table 526. The zoning configuration table 526 is a table indicating a state of zoning configuration in the FC switch 500. The zoning configuration table 526 has, for each zone set, a state flag indicating a configuration state of zoning, a zone set name, and a zone list belonging to the zone set. The state flag is indicated as “active” when the configuration of the zone set is effective and indicated as “deactive” when the configuration of the zone set is not effective. A zone described in the zone list is a zone defined in the zone definition table 524. When a zone configuration table update request from the management computer 400 is received, the CPU 510 of the FC switch 500 judges whether a zone set included in the request has already been defined in the zoning configuration table 526. If the zone set has already been defined, the CPU 510 updates the zone set of the zoning configuration table 526. If the zone set name has not been defined, the CPU 521 updates the zoning configuration table 526 on the basis of a zone set name, a zone name, and activation selection information included in the request and returns an update completion notice to the management computer 400.

The FC switch 500 refers to a zone of the zone definition table 524 to specify a member of the zone from a zone name that is a component of a zone set for which the state flag of the zoning configuration table 526 is set to “active” and controls communication only among members of the zone. Consequently, exclusive control for accesses from host computers and data storage apparatuses to data storage areas is realized in the FC switch 500.

Management Computer 400

The management compute 400 includes a CPU 410 for executing programs, a memory 420 for storing programs and data to be executed by the CPU 410, and the management port 490 for connecting the management computer 400 to the host computer 300, the FC switch 500, the data storage apparatus A 100, and the data storage apparatus B 200 via the management network 90. The management computer 400 further includes a display 401 for presenting necessary information to an administrator and displaying a setting screen used by the administrator and a keyboard 402 and a mouse 403 that receive inputs from the administrator. The memory 420 has the special zone management table 422, a special zone detection program 425, and a zone set activation program by external port 427. The programs and the table are stored in a recording medium such as a hard disk, loaded on the memory 420 when a data storage apparatus runs, and executed by the CPU 410, whereby functions of the programs and the table are realized.

[Special Zone Management Table 422]

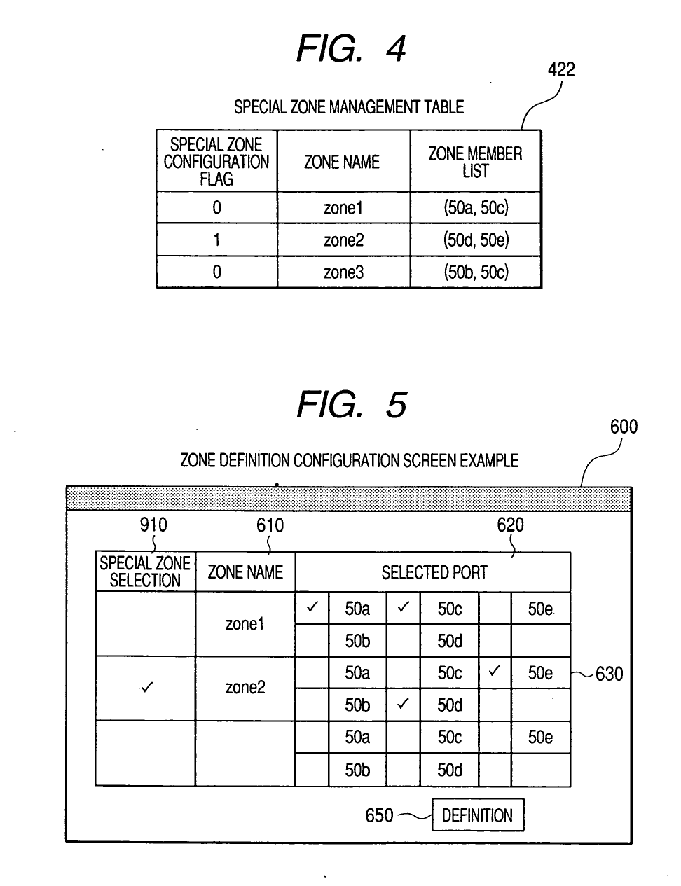

As shown in FIG. 4, the special zone management table 422 has, for each zone, a zone name, a zone member list, and a special zone configuration flag. However, the CPU 410 updates the zone name and the zone member list according to the zone definition table 524 when a zone definition table update completion notice from the FC switch 500 is received. In addition, the special zone configuration flag is information that is added when the special zone detection program 425 detects that the zone is a zone permitting data communication between the data storage apparatus A 100 and the data storage device B 200 (the special zone configuration flag is set to “0” as default). When the special zone configuration flag is “1”, the special zone configuration flag indicates that the zone is a zone for connecting the data storage apparatus A 100 and the data storage apparatus B 200. In other words, the special zone configuration flag indicates that the zone is a zone necessary for providing data from a data storage apparatus to a host computer.

Zone Definition Method

[Zone Definition Setting Screen 600]

FIG. 5 is an example of a zone definition setting screen 600 that performs definition setting for zones and definition change for zones. The zone definition setting screen 600 has a zone name column 610, a selected port column 620, and a definition button 650 for executing zone definition operation. A special zone selection column 910 is not used in first and second embodiments.

When a zone has already been defined, a zone name of the zone is listed in the zone name column 610. A switch port number acquired from the link information management table 522 of the FC switch 500 is listed in the selected port column 620. When a zone has already been defined, a switch port number corresponding as a member of the zone is checked.

When an administrator defines a zone anew, on the zone definition setting screen 600 displayed on the display 401, the administrator inputs a zone name in the zone name column 610 using the keyboard 402 and the mouse 403, selects a switch port, which becomes a zone member, in the selected port column 620, and presses the definition button 650. When the administrator changes a member of a zone, the administrator selects a port in the selected port column 620 again, and presses the definition button 650. The special zone detection program 425 performs the same processing for the definition of a new zone and the change of a zone definition. In the following explanation, in particular, as a new zone, a zone shown on a row 630 is set as a “zone 2” and numbers of switch ports, which become zone members, are set as “50d” and “50e”.

[Processing Flow of the Special Zone Detection Program 425]

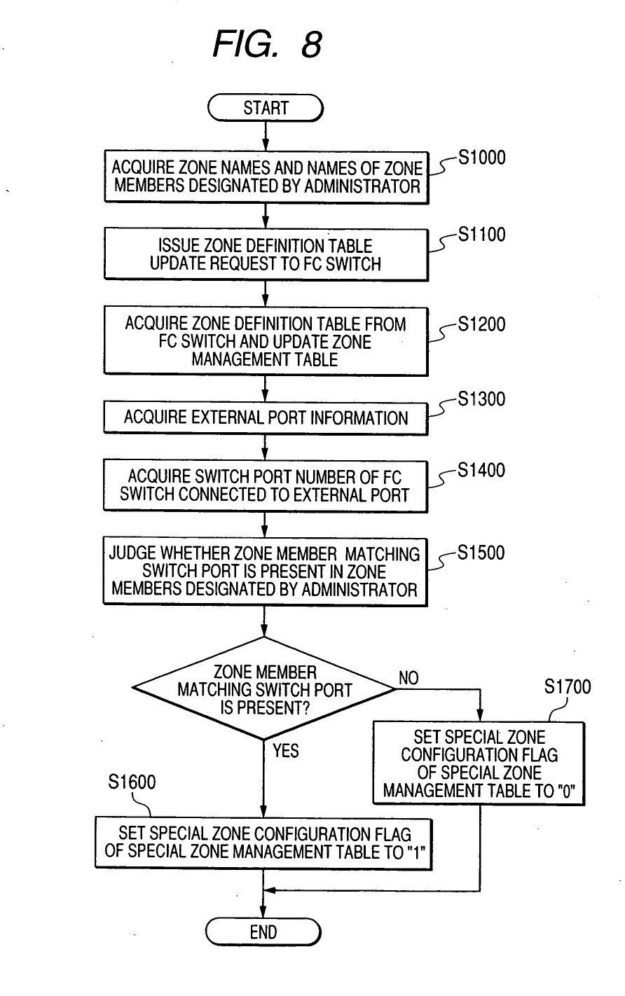

FIG. 8 shows a processing flow of the special zone detection program 425 that is executed by the CPU 410 of the management computer 400. The CPU 410 executes this processing by reading out the special zone detection program 425 from the memory 420 with press of a “definition” button 650 on a zone definition configuration screen 600 by an administrator. When the “definition” button 650 is pressed, the CPU 410 acquires a zone name designated by the administrator and a number of a switch port that becomes a selected zone member (step S1000). Here, processing at the time when a zone name has not been inputted or an FC port has not been selected is not explained.

Next, the CPU 410 issues a zone definition table update request based on the acquired zone name and switch port number to the FC switch 500 (step S1100). When an update completion notice from the FC switch 500 is received, the CPU 410 acquires the zone definition table 524 from the FC switch 500 and updates the zone name column and the zone member list column of the special zone management table 422 (step S1200). Next, the CPU 410 acquires a WWN (in this case, wwn_10b) from the data storage apparatus port management table 124 of the data storage apparatus A 100 as information on an external port via the management port 490 (step S1300). Then, the CPU 410 acquires the link information management table 522 from the FC switch 500 and refers to a switch port number (in this case, 50d) with a link destination WWN “wwn_{—}10b” (step S1400).

Next, the CPU 410 judges whether a zone member matching the acquired switch port number 50d is present in zone members designated by the administrator (step S1500). When there is a zone member matching the acquired switch port number 50d, the CPU 410 sets the special zone configuration flag of the special zone management table 422 to “1” (step S1600). When there is no zone member matching the acquired switch port number 50d, the CPU 410 sets the special zone configuration flag of the special zone management table 422 to “0” (step S1700).

Configuration Change for Zoning

In the following explanation, the CPU 410 performs processing for defining a zone set according to an input by an administrator and activating the defined zone set. However, it is assumed that the special zone management table 422 of the management computer 400 is in the state of FIG. 4 and the zoning configuration table 526 is in an initial state shown in FIG. 3C. It is also assumed that a zoneset A has already been created using means to be explained below. This state is a state in which zones, zone 1 and zone 2, are active and the host computer 301 is using the virtualized data storage area 162 of the data storage apparatus A 100. In this state, in order to allow the host computer 302 to use the virtualized data storage area 162 of the data storage apparatus A 100, a new zoneset B including a zone 3 is created and activated. This processing will be explained.

[Zoning Configuration Screen]

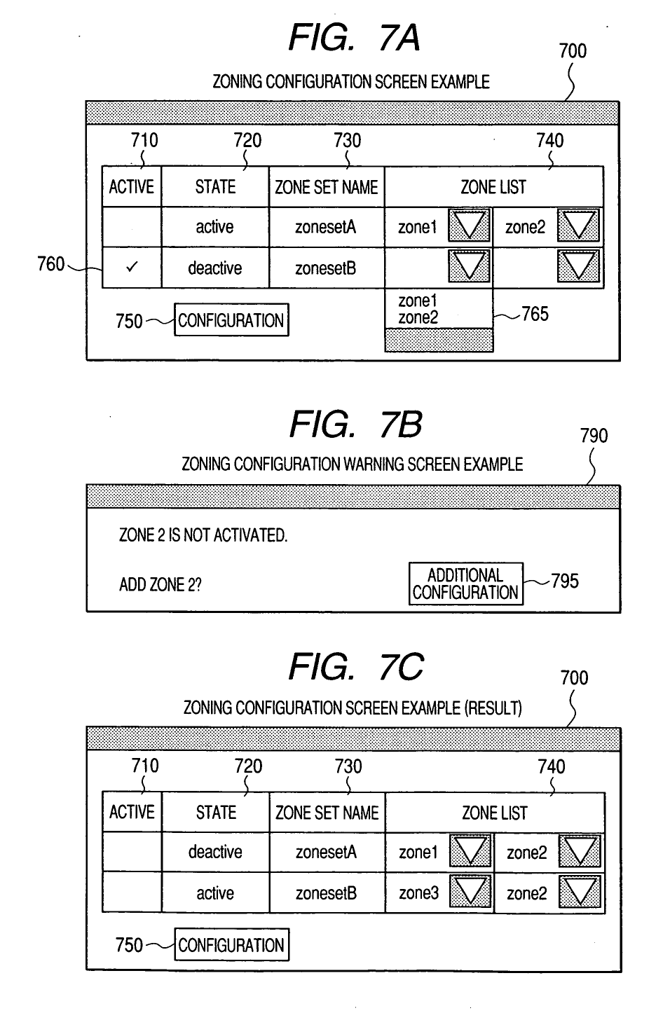

FIG. 7A is a diagram showing an example of the zoning configuration screen 700 that is a screen for performing definition of a zone set, activation of the zone set, and definition change for the zone set. The zoning configuration screen 700 has an activation selection column 710, a state column 720 showing a state of configuration of zoning that is set at the present point, a zone set name column 730, a zone list column 740 that is a list of zones belonging to a zone set, and a configuration button 750. Information on the zone set zoneset A displayed on the zoning configuration screen 700 is information that the management computer 400 obtained with reference to the zoning configuration table 526 (in this case, the zoning configuration table 526 is in the state of FIG. 3C). The zone list column 740 adopts a pull-down menu form such that a zone can be selected from menus. Zones displayed on a pull-down menu 765 are zones defined in the special zone management table 422 (in this case, zone names of the special zone management table 422 shown in FIG. 4 are displayed).

When an administrator defines a zone set anew or change a definition of a zone set, the administrator confirms the zoning configuration screen 700 displayed on the display 401, inputs a zone set name in the zone set name column 730 using the keyboard 402 and the mouse 403, selects a zone to be registered in the zone list column 740 from the pull-down menu 765, and presses the configuration button 750. At this point, if the administrator checks the activation selection column 710 and presses the configuration button 750, it is possible to activate the zone set simultaneously with the definition of the zone set. Moreover, to change a defined zone set, the administrator changes the zone set on the screen and presses the configuration button 750. Note that only two zones can be selected at the most in the zone list 740 shown in FIG. 7. However, this is for simplification of explanation of this embodiment. There is no limitation on the number of zone that can be actually selected.

In processing to be explained below, in particular, as a new zone set, a zone set name shown on a row 760 is set as “zoneset B”, a zone registered in the zoneset B is “zone 3” (it is assumed that a zone 2 is not registered), and the activation selection column 710 is checked.

[Processing Flow of the Zone Set Activation Program by External Port 427]

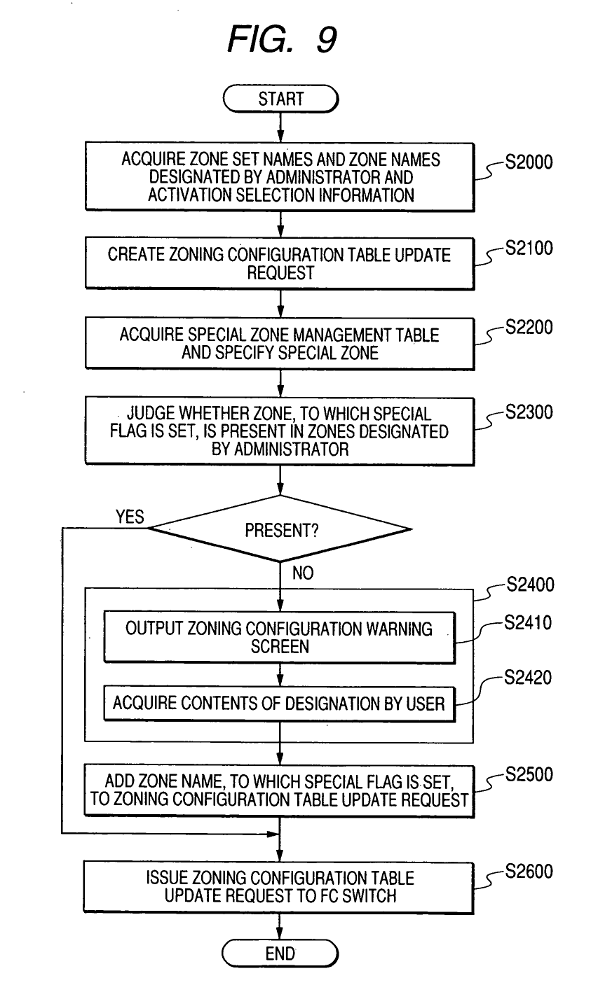

FIG. 9 shows a processing flow of the zone set activation program by external port 427 that is executed by the CPU 410 of the management computer 400. The CPU 410 executes this processing by reading out the zone set activation program by external port 427 from the memory 420 with press of the configuration button 750 on the zoning configuration screen 700 by an administrator. The CPU 410 acquires a zone set name designated by the administrator, a selected zone name, and activation selection information (“active” when the administrator checks the activation selection column 710, otherwise, “deactive”) (step S2000). Here, processing at the time when a zone set name has not been inputted or a zone has not been selected is not explained. Next, the CPU 410 creates a zoning configuration table update request, which is issued to the FC switch 500, including the information acquired in step S2000 (step S2100). When the creation of the zoning configuration table update request is completed, the CPU 410 acquires the special zone management table 422 and specifies a zone for which the special zone configuration flag is set to “1” (step S2200). Then, the CPU 410 judges whether the zone specified in step S2200 is included in the zones designated by the administrator (step S2300). When the specified zone is included in the designated zones, the CPU 410 jumps to step S2600.

When the specified zone is not included in the designated zones, the CPU 410 outputs a message “zone 2 is not activated” shown in FIG. 7B to a display 401 for notifying to the administrator on a zoning configuration warning screen 790 (step S2410). This screen 790 has a message such as “add zone 2?” which prompts the administrator to add the zone 2 as the member of the zonesetB, and an “additional configuration” button 795 to add zone2 as the member of the zonesetB.

After outputting the zoning configuration warning screen 790, the CPU 410 acquires information of a button selected by the administrator (step S2420). When the “additional configuration” button 795 is pressed, the CPU 410 adds the zone 2 in the zoning configuration table update request in addition to the zone set name, the zone name, and the activation selection information acquired in step S2000 (step S2500). Note that step S2400 relating to the zoning configuration warning screen 790 does not have to be performed.

Then, the CPU 410 issues the created zoning configuration table update request to the FC switch 500 (step S2600). When an update completion notice is received, the CPU 410 updates the zoning configuration screen 700 as shown in FIG. 7C. FIG. 7C indicates that the zone 2, which the administrator does not include in the zoneset B, is registered in the zone list. Here, the processing ends.

In the processing explained above, a zone, which has an FC port of a first-tier data storage apparatus for connecting with a second-tier data storage apparatus as a member, is set as a special zone and this special zone is activated at the time of zoning configuration. In the first embodiment, even if an administrator defines a zone set without knowing that a data storage area is provided by virtualization, since a zone for controlling mutual communication between the data storage apparatus A 100 and the data storage apparatus B 200 is registered in a zone set, it is possible to guarantee an access to a data storage area storing actual data from a host computer.

In other words, by setting a special zone as a special zone and activating the special zone, even if a zoning configuration is changed, that is, active/inactive of a zone set is switched, communication between a virtualized data storage area and a storage area storing actual data is guaranteed. Thus, the administrator can carry out an intended operation.

In addition, when a zone set is defined anew, it is possible to reduce a configuration load on an administrator. When an administrator of switches and an administrator of data storage apparatuses are different, for example, the administrator of the switch managing access control between a host computer and a device as well as among plural devices can set an access permission path without considering a hierarchical relation of data storage apparatuses that is managed by the administrator of data storage apparatuses.

Supplementary Explanation About Timing for Executing Processing

In the explanation of this embodiment, the CPU 410 of the management computer 400 executes the special zone detection program 425 according to a zone definition instruction from an administrator. It is also possible that the CPU 410 is invoked by the zone set activation program by external port 427 and executes the program at the time of zone set definition.

In a second embodiment of the invention, an association between a zone for connecting a host computer and a first data storage apparatus and a zone for connecting the first data storage apparatus and a second data storage apparatus is detected based on a configuration of a data storage area and the second zone associated with the first zone is also added as the member of a zone set such that the zone is activated. In addition, if a second zone is not defined, a zone is defined and included in the zone set.

Explanation of an Outline of this Embodiment

In the first embodiment, the method of adding a zone for connecting the data storage apparatus A 100 and the data storage apparatus B 200 for all zone set to thereby always activate the zone is explained. In this embodiment, an addition method at the time when a zone, which should be added, is different depending on a zone set to be activated will be explained.

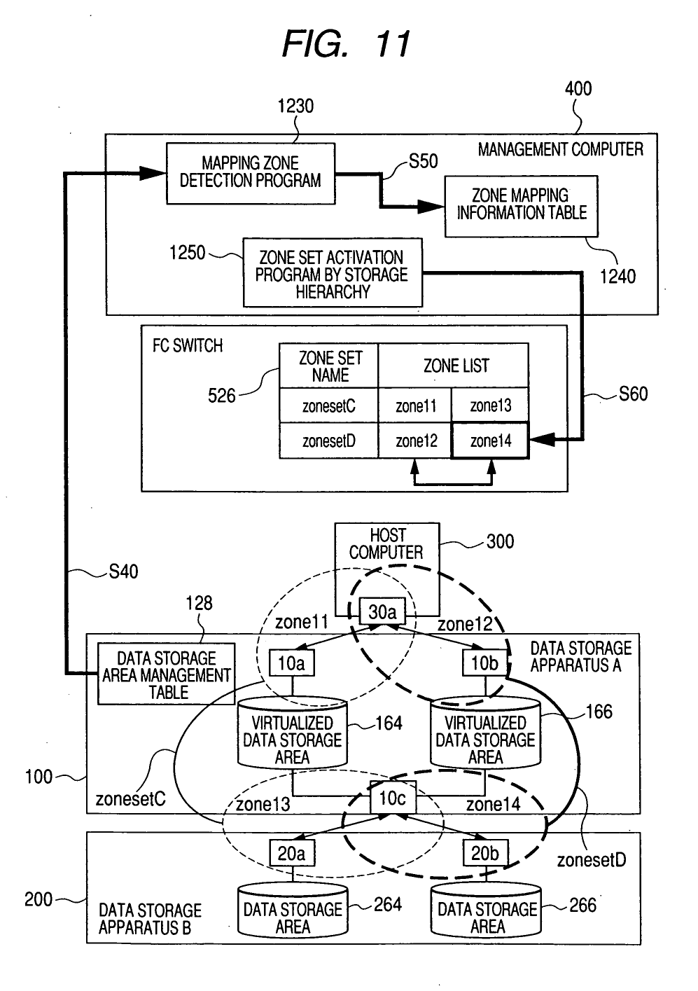

First, an outline of this embodiment will be explained with reference to FIG. 11. In a configuration shown in FIG. 11, the management computer 400 has a zone mapping information table 1240, a mapping zone detection program 1230 associating a special zone with a special zone on the basis of a configuration of a data storage area, and a zone set activation program by storage hierarchy 1250 for registering an external zone in a zone set in accordance with the zone mapping information table 1240. The data storage apparatus A 100 provides a host computer with virtualized data storage areas 164 and 166, and the data storage apparatus B 200 provides a host computer data storage areas 264 and 266. The data storage apparatus A 100 holds a data storage area management table 128 indicating a state in which the virtualized data storage area 164 and the data storage area 264 as well as the virtualized data storage area 166 and the data storage area 266 are constituted hierarchically.

In the following explanation, it is assumed that the virtualized data storage area 166 is a copy of the virtualized data storage area 164 and the host computer 300 has a database control program (not shown) and a backup control program (not shown). Moreover, in an operation form assumed in the explanation, usually, the database control program carries out job processing using the virtualized data storage area 164 (actual data is stored in the data storage area 264) but, at night, the backup control program carries out backup processing (e.g., data copy to a tape library or the like) using the virtualized data storage area 166 (actual data is stored in the data storage area 266). In other words, when a zone 11 and a zone 13 are configured as active zones, respectively, and the database control program on the host computer 300 is using the virtualized data storage area 164 (actual data is stored in the data storage area 264), it is assumed that a data storage area to be used by the host computer is switched to the virtualized data storage area 166 (actual data is stored in the data storage area 266) for backup processing. A method of carrying out job processing in this case will be explained.

[Definition of a Zone]

In the first embodiment, the CPU 410 of the management computer 400 specifies an FC port of the data storage apparatus A 100 for connecting the data storage apparatus A 100 with the data storage apparatus B 200 using the special zone detection program 425 and configures a zone, which has the FC port as a member, as a special zone. In the second embodiment, the CPU 410 acquires association information of the virtualized data storage area 164 of the data storage apparatus A 100 and the data storage area 264 of the data storage apparatus B 200 from the data storage area management table 128 (S40). In the configuration of FIG. 11, the CPU 410 specifies that a zone 12 and a zone 14 are related and creates the zone mapping information table 1240 (S50). The CPU 410 defines that the zone 14 is a special zone for the zone 12.

[Outline of Configuration of Zoning]

When an instruction for creating a zone set is received a request for zoning from a management computer, when a zone set having the zone 12 as a member is created, the zone set activation program by storage hierarchy 1230 judges whether the zone 14 is included the zone set with reference to the zone mapping information table 1240. If the zone 14 is not included in the zone set, the zone set activation program by storage hierarchy 1230 includes the zone 14 in the zone set (S60).

In this way, the combination of zones with relation is added to a zone set such that the zones are always activated simultaneously. This makes it possible to change a zone configuration while maintaining a relation between a virtualized data storage area and a data storage area.

System Configuration

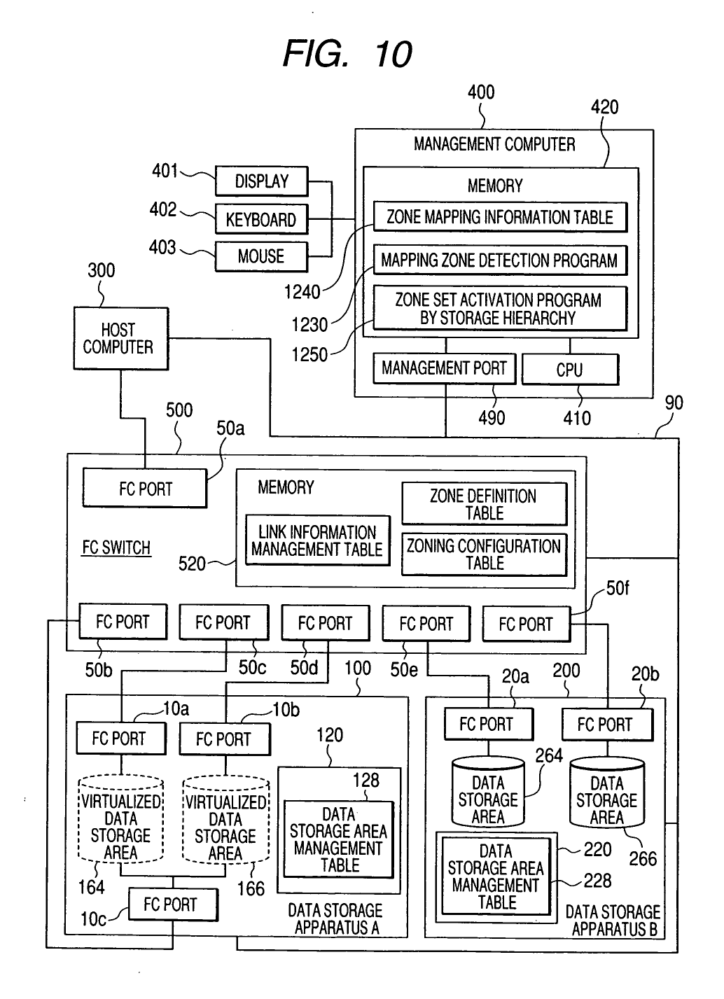

FIG. 10 shows a detailed configuration of a computer system in the second embodiment. The second embodiment is different from the first embodiment in that there is only one host computer 300 and the number of FC ports for connecting with the FC ports of the data storage apparatus B 200 is increased in the FC switch 500. Note that the numbers of FC switches and the number of data storage apparatuses are not limited to those in this embodiment.

Data Storage Apparatus A 100 and Data Storage Apparatus B 200

[Data Storage Area Management Tables 128 and 228 of Data Storage Apparatuses]

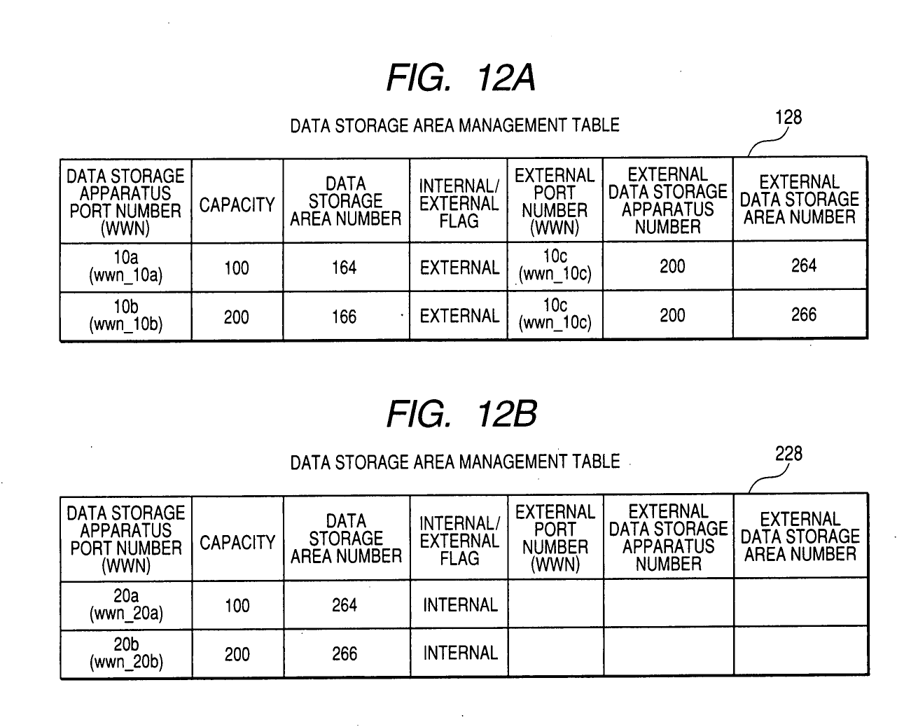

In the data storage apparatus A 100 and the data storage apparatus B 200, the data storage area management tables 128 and 228 are different from the data storage area management tables 122 and 222 explained in the first embodiment. FIGS. 12A and 12B show examples of the data storage area management tables 128 and 228 in this embodiment. The data storage area management tables 128 and 228 have, for each data storage area, a data storage apparatus port number (WWN) that is information on an FC port assigned to the data storage area, a capacity of the data storage area, a number of the data storage area, an internal/external flag, an external port number (WWN) for the data storage apparatus A 100 to connect with another data storage apparatus, an external data storage apparatus number that is a name of another data storage apparatus, and an external data storage area number.

Here, the internal/external flag is a flag that indicates whether a data storage area storing actual data is present in the data storage apparatus or present in a second-tier data storage apparatus. In this embodiment, the flag at the time when the data storage area storing actual data is present in the data storage apparatus is “internal” and the flag at the time when the data storage area storing actual data is present in a second-tier data storage apparatus is “external”. In the example of the data storage area management table 128 of the data storage apparatus A 100 shown in FIG. 12A, the flags of the data storage areas with the data storage area numbers 164 and 166 are “external”. This indicates that these data storage areas are virtualized data storage areas and actual data is present in a second-tier data storage apparatus. In this example, the internal/external flags of the two data storage areas are “external”. However, it is also possible that one of the internal/external flags is “internal” and the other is “external”. In other words, a data storage area storing actual data and a virtualized data storage area may be mixed in one data storage apparatus. When the internal/external flag is “internal”, the external port number column (WWN), the external data storage apparatus column, and the external data storage area number column are left blank. Similarly, the two data storage areas in the example of the data storage area management table 228 of the data storage apparatus B 200 shown in FIG. 12B indicate that actual data is present in the data storage apparatus B 200. In FIG. 12B, it is also possible that one of the internal/external flags is “internal” and the other is “external”. For example, when the internal/external flag of the data storage area with the data storage area number 264 is set as “external” and values are set in the external connection port number (WWN) column, the external data storage apparatus number column, and the external data storage area number column, there is a data storage apparatus, in which a data storage area storing actual data is present, in an another data storage apparatus.

FC Switch 500

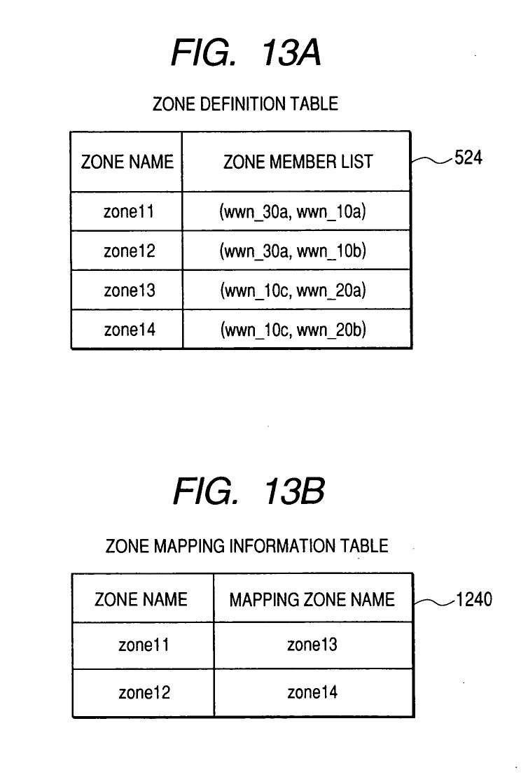

A configuration of the FC switch 500 in this embodiment is basically the same as that in the first embodiment. However, in this embodiment, as shown in FIG. 13A, in the zone definition table 524, zones are defined by designating WWNs of FC ports of host computers and WWNs of FC ports of a data storage apparatus, which are link destinations of switch ports. Zones may be designated by FC port numbers of an FC switch as in the first embodiment.

In this embodiment, the link information management table 522 and the zoning configuration table 526 are similar to those explained in the first embodiment with some changes added to those shown in FIGS. 3A and 3C (not shown). In the link information management table 522 in this embodiment, a switch port number 50f is added to and a combination of link destination WWNs is changed from the link information management table 522 shown in FIG. 3A. In the zoning configuration table 526 in this embodiment, the zoneset A, the zone 1, the zone 2 in the zoning configuration table 526 in FIG. 3C are changed to a zoneset C, a zone 11, and a zone 13, respectively.

Management Computer 400

In order to realize the second embodiment, the management computer 400 has the zone mapping information table 1240, the mapping zone detection program 1230, and the zone set activation program by storage hierarchy 1250.

[Definition of a Zone]

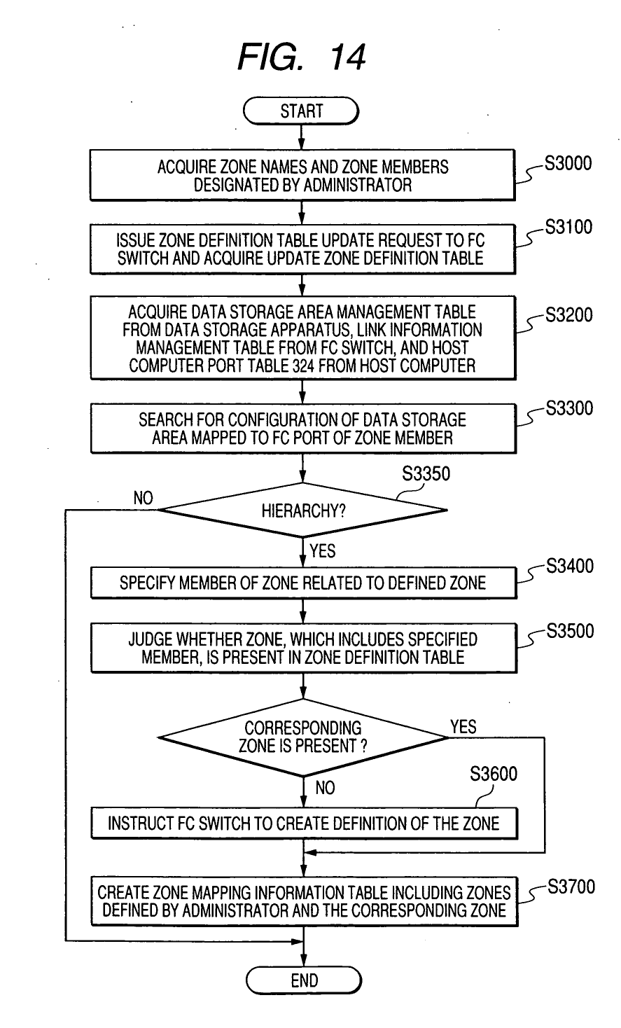

An administrator defines zones in the FC switch 500 using the zone definition setting screen 600 shown in FIG. 5 that is explained in the first embodiment. In FIG. 5, FC ports of an FC switch are selected to define zones. However, it is also possible to constitute a screen for causing the administrator to select FC ports of host computers and data storage apparatuses using link destination WWNs of the link information management table 522 of the FC switch 500. In the following explanation, processing of the mapping zone detection program 1230 at the time when a zone 12 is defined a new will be explained with reference to FIG. 14.

The mapping zone detection program 1230 acquires a zone name (in this case, “zone 12”) and zone members (in this case, “www_{—}30a” and “www_{—}10b”) designated by the administrator (step S3000). Next, the mapping zone detection program 1230 issues a request for updating the zone definition table 524 based on the information acquired in S3000 to the FC switch 500. When an update completion notice from the FC switch 500 is received, the mapping zone detection program 1230 acquires an updated zone definition table 524 (step S3100).

Next, the mapping zone detection program 1230 acquires the data storage area management tables 128 and 228 from the data storage apparatuses A 100 and B 200, acquires the link information management table 522 from the FC switch 500, and acquires the host computer port table 324 from the host computer 300 (S3200). Next, the mapping zone detection program 1230 searches for a configuration of a data storage area mapped to FC ports of members of the zones designated by the administrator (S3300).

A method of searching for a configuration of a data storage area in step S3300 in the case of this embodiment is specifically described as follows. First, the mapping zone detection program 1230 specifies that, in the members of the zone 12 defined anew, the “wwn_{—}30a” is an FC port of the host computer 300 and the “wwn_{—}10b” is an FC port of the data storage apparatus A100.

Next, the mapping zone detection program 1230 refers to the data storage area management table 128 of the data storage apparatus A 100 to thereby judge whether the data storage area (the virtualized data storage area 166) mapped to the FC port of the “wwn_{—}10b” has the internal/external flag set to “external” and has a hierarchical configuration (S3350). As a result of the judgment, if the internal/external flag is “internal” (“No” in step S3350), the mapping zone detection program 1230 ends the processing.

If the data storage area is configured hierarchically (“Yes” in step S3350), the mapping zone detection program 1230 proceeds to the next step S3400.

In step S3400, the mapping zone detection program 1230 specifies members of a zone mapping to the defined zone. The method of specifying a member is specifically described in the case of this embodiment as follows. First, from the data storage area management table 128 of the data storage apparatus A 100 and the data storage area management table 228 of the data storage apparatus B 200, the mapping zone detection program 1230 finds that this virtualized data storage area 166 is assigned to an FC port having a name “wwn_{—}20b” through an FC port having a name “wwn_{—}10c”. Thus, the mapping zone detection program 1230 specifies that members of the zone associated with a zone designated by the administrator are a “wwn_{—}10c” and “wwn_{—}20b” (step S3400) Next, the mapping zone detection program 1230 judges whether a zone having these members has already been defined in the zone definition table 524 (step S3500). If the zone is present, the mapping zone detection program 1230 jumps to step S3700. In the case of this embodiment, since the zone is present, the mapping zone detection program 1230 proceeds to step S3700.

If the zone is not defined, the mapping zone detection program 1230 issues a zone definition table update request to the FC switch 500 in an attempt to define a new zone, which has the “wwn_{—}10c” and the “wwn_{—}20b” are members, in the FC switch 500. When a completion notice from the FC switch 500 is received, the mapping zone detection program 1230 proceeds to the next step S3700. In that case, it is assumed that a name like “zone *” (* is a smallest number among set numbers) is automatically allocated to a zone name. Next, the zone mapping detection program 1230 adds the zone designated by the administrator (in this case, the zone 12) and the zone found in step S3500 (in this case, the zone 14) in the zone mapping information table 1240 (step S3700). With such processing, the zone mapping information table 1240 has a configuration shown in FIG. 13B.

FIG. 13B is a diagram showing a configuration of the zone mapping information table 1240.

In the zone mapping information table 1240, a name of a certain zone and a name of a mapping zone found in step S3500 are associated with each other. When a zone associated with a mapping zone of a mapping zone name is activated by processing described later, the mapping zone is also activated. The mapping zone is not limited to one zone.

[Configuration Change for Zoning]

In the following explanation, according to an input by an administrator, the management computer 400 defines a zone set zoneset D with the zone 12 as a member (assuming that the zone 14 is not set as a, member) anew such that the host computer 300 can use the virtualized data storage area 166. On the zoning configuration screen 800 showing in FIG. 7A used in the explanation of the first embodiment, as in the first embodiment, when the administrator inputs a zone set name (in this case, for example, “zoneset D”) in a zone set name column, selects a zone (in this case, only “zone 12”) in a zone list column, checks an activation selection column, and presses a configuration button with an input device such as a keyboard or a mouse, the management computer 400 starts processing of the zone set activation program by storage hierarchy 1250.

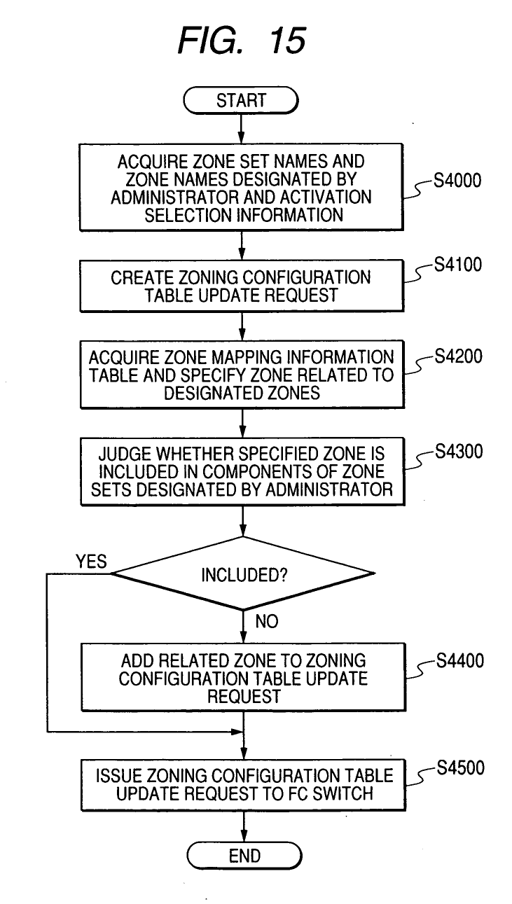

The processing of the zone set activation program by storage hierarchy 1250 after the configuration button 750 is pressed will be hereinafter explained with reference to FIG. 15.

First, the CPU 410 of the management computer 400 acquires a zone set name (in this case, “zoneset D”) designated by the administrator using the zoning configuration screen 700, a zone (in this case, “zone 12”, but “zone12” is not shown in FIG. 7A) that is a member, and information on whether an activation selection button is pressed (in this case, “active”) (step S4000). Next, the CPU 410 creates a zoning configuration table update request based on the information acquired in step S4000 (step S4100). Next, the CPU 410 acquires the zone mapping information table 1240, judges whether a zone associated with the zone 12, which is the zone designated by the administrator, is a member of the zone set(in this case, “zonset D”). As a result of the judgment, if a zone associated with the zone 12 is a member, the CUP 410 specifies a zone associated with the zone 12 from a mapping zone name (step S4200). As shown in FIG. 13B, in the case of this embodiment, the zone associated with the zone 12 is the zone 14.

Next, the CPU 410 judges whether the administrator has designated a zone identical with this zone 14 (S4300). If a zone identical with the zone 14 is present, the CPU 410 jumps to step S4500. If a zone identical with the zone 14 is not present, the CPU 410 adds the zone 14 to the zoning configuration table update request created in step S4000 (S4400). Moreover, the CPU 410 issues the zoning configuration table update request to the FC switch 500 (S4500) and acquires a completion notice from the FC switch 500. Here, the CPU 410 ends the processing.

Supplementary Explanation About Timing for Executing Processing

Note that, in this embodiment, the CPU 410 executes the mapping zone detection program 1230 according to a zone definition instruction from the administrator. However, it is also possible that the CPU 410 is invoked by the zone set activation program by storage hierarchy 1250 and executes the program at the time of zone set definition.

Supplementary Explanation About the System Configuration

Note that, in this embodiment, the host computer 300 and the data storage apparatus A 100 as well as the data storage apparatus A 100 and the data storage apparatus B 200 are connected by one FC switch 500. However, the host computer 300 and the data storage apparatus A 100 as well as the data storage apparatus A 100 and the data storage apparatus B 200 may be connected by different two FC switches separately. Moreover, the two FC switches may be connected to each other by fibre channel to form one fabric. Note that, when the host computer 300 and the data storage apparatus A 100 as well as the data storage apparatus A 100 and the data storage apparatus B 200 are connected by the two different FC switches, a zone set to be activated by a second FC switch connecting the first data storage apparatus A 100 and the data storage apparatus B 200 is switched according to a change in a zoning configuration of a first FC switch connecting the host computer 300 and the data storage apparatus A 100.

Moreover, in the second embodiment, it is also possible that one of two host computers is connected to the FC port 10a of the data storage apparatus A 100 and the other is connected to the FC port 10b of the data storage apparatus A 100. In addition, it is also possible that one of two FC ports of the data storage apparatus A 100 for connecting the data storage apparatus A 100 with the second-tier data storage apparatus B 200 is connected to the FC port 20a of the data storage apparatus B 200 and the other is connected to the FC port 20b of the data storage apparatus B 200. In other words, the zone 11 and the zone 12 as well as the zone 13 and the zone 14 may have completely different FC ports as members, respectively.

In the processing explained above, a relation between a virtualized data storage area and a data storage area storing actual data is grasped, a zone for connecting a host computer and a first-tier data storage apparatus and a zone for connecting a first-tier data storage apparatus and a second-tier data storage apparatus are associated with each other, and in response to switching for activating an first zone, a second zone is also activated.

According to this embodiment, when a zone set is configured on the basis of hierarchy information according to a storage location of data used by a host computer, it is possible to reduce a load on an administrator.

### Third Embodiment

In a third embodiment of the invention, a module for defining a zone between the data storage apparatus A 100 and the data storage apparatus B 200 as a special zone and a module for always adding the special zone as a member of a zone set to activate the zone are provided in the FC switch 500, whereby the zone is set in an active state without depending on a configuration change for zoning.

Schematic Explanation of this Embodiment

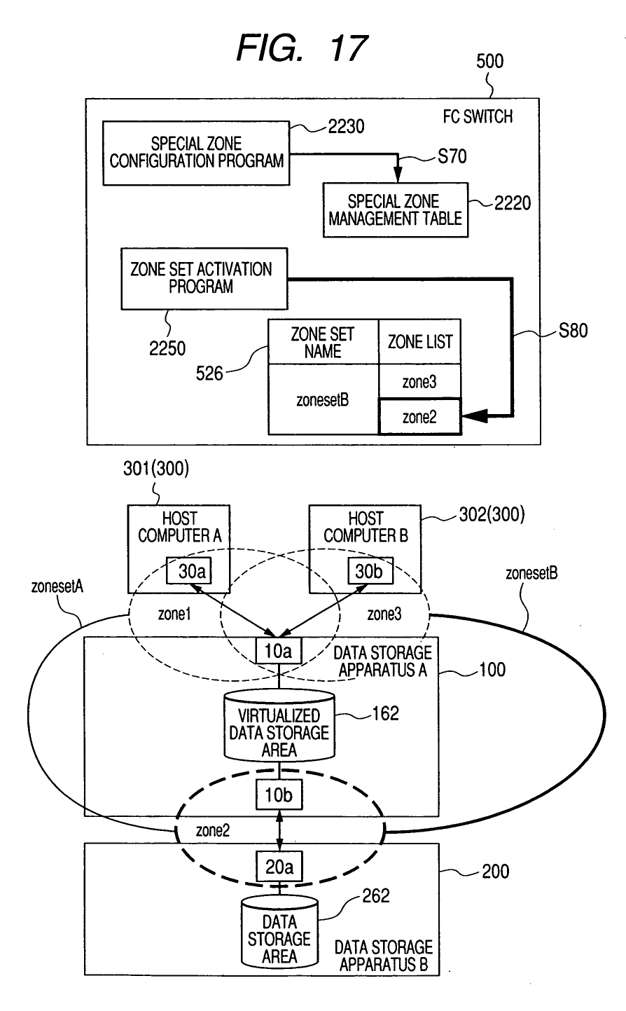

Before explaining this embodiment, this embodiment will be explained schematically with reference to FIG. 17. The special zone management table 422, which is provided in the management computer 400 in the first embodiment, is provided in the FC switch 500. In addition, a special zone configuration program 2230 for setting the special zone management table 422 and a zone set activation program 2250 for activating a special zone are provided. In this embodiment, an administrator selects a zone to configure the special zone and a zoneset activation program 2250 adds the special zone as a member of a zone set. Then, when a FC switch configures zoning including a FC port of FC Switch to be connected to a host computer, the FC switch also configures the special zone to make it possible to use a data storage area of the data storage apparatus B 200 storing actual data from the host computer.

The administrator issues to the FC switch 500 a request for configuring a zone between the data storage apparatus A 100 and the data storage apparatus B 200 as a special zone using the management computer (not shown in FIG. 17). When a request from the management computer 400 is received, the special zone configuration program 2230 configures a specific zone as a “special” zone (S70) and holds the configured information in the special zone management table 2230. When the zoning on figuration changes, the zone activation program 2250 includes the zone configured as the special zone in the zone set with reference to the special zone management table 2230 (S80).

System Configuration

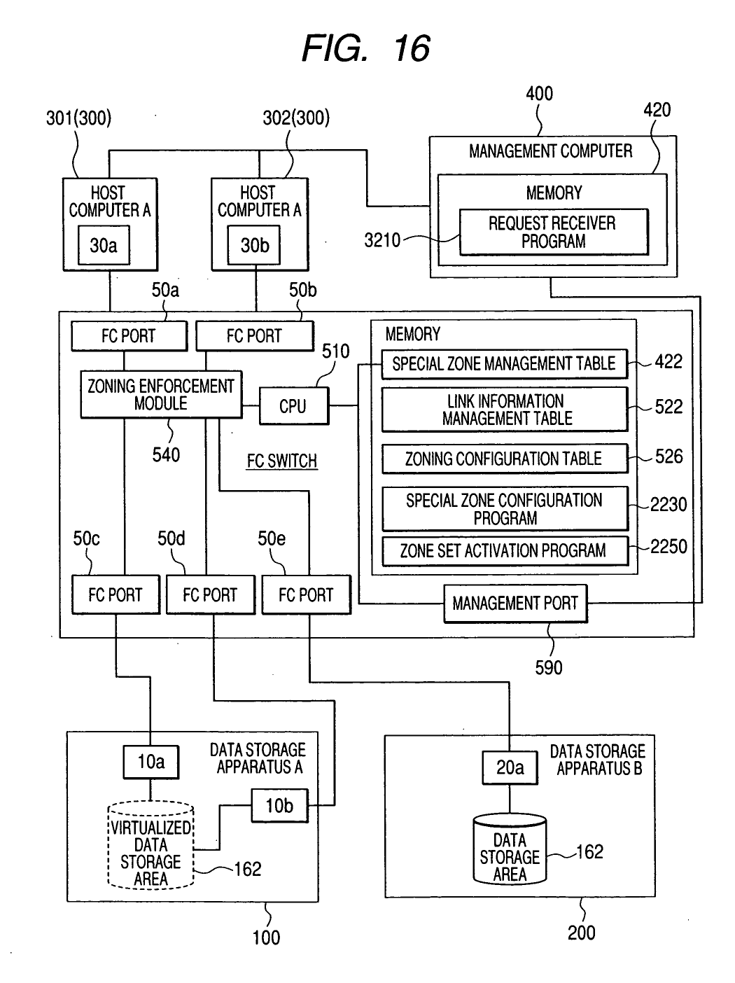

FIG. 16 shows an example of a system configuration carrying out the invention. The system configuration is basically the same as that in the first embodiment. However, in order to realize this embodiment, the special zone management table 422, the link information management table 522, the zoning configuration management table 526, the special zone configuration program 2230, and the zone activation program 2250 are provided in the FC switch 500. In addition, a request receiver program 3210 for performing zone definition and zoning configuration in the FC switch 500 is provided.

FC Switch 500

Here, the tables and the programs provided anew in this embodiment will be explained. The special zone management table 422 is the same as that shown in FIG. 4 and has, for each zone, a special zone configuration flag, a zone name, and a zone member list. A zone with the special zone configuration flag set to “1” indicates a “special” zone that should always be activated. The link information management table 522 is the same as that shown in FIG. 3A and the zoning configuration table 526 is the same as that shown in FIG. 3C. When a special zone management table update request from the management computer 400 is received, the FC switch 500 acquires a zone name included in the request and judges whether the zone name has already been defined in the special zone management table 2200. If the zone has been defied, the FC switch 500 updates information on the zone. If the zone has not been defined, the FC switch 500 adds a zone anew to update the special zone management table 2200. When the update is completed, the FC switch 500 issues an update completion request to the management computer 400. In the third embodiment, only one FC switch is provided. However, for example, when plural FC switches are connected to one another to form a fabric, the program is executed in an FC switch serving as a master FC switch.

[Special Zone Configuration Method]

To configure a zone as a special zone, the zone definition setting screen 600 shown in FIG. 5 is used. The third embodiment is different from the first and the second embodiments in that a special zone selection column 910 is added. By selecting this special zone selection column 910 via an input device, an administrator can select a zone in the special zone selection column 910 as a special zone.

The CPU 410 of the management computer 400 executes the request receiver program 3210 with press of the definition button 650 . First, the CPU 410 acquires a zone name (in this case, “zone 2”), names of selected ports (in this case, “50d” and “50e”), and information on whether a special zone selection flag is selected (when the special zone selection flag is selected, for example, “1”, and when the special zone selection flag is not selected, for example, “0”). The CPU 410 transmits to the FC switch 500 a special zone configuration request including the acquired information.

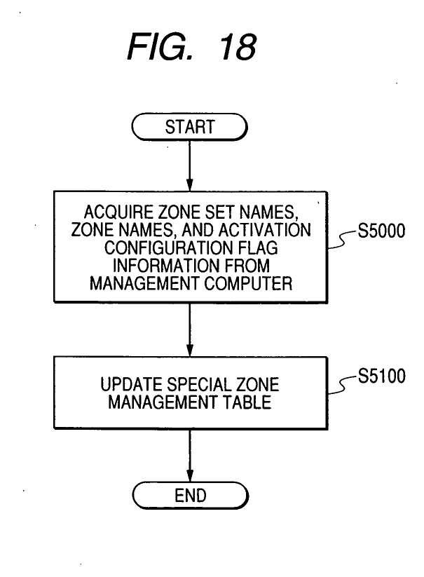

A processing flow of the special zone configuration program 2230, which is executed by the CPU 510 of the FC switch 500, will be explained with reference to FIG. 18. When a special zone configuration request is acquired from the management computer 400, the CPU 510 acquires information on a zone name, a zone member name, and a special zone selection flag from the request (S5000). Next, the CPU 510 updates the special zone management table 422 on the basis of the acquired information (S5100). When the update ends, the CPU 510 sends a completion notice to the management computer 400.

[Configuration Change for Zoning]

Here, as in the first embodiment, the zone activation program 2250 at the time when an active zone set with the zoneset B as a name is defined anew will be explained with reference to the zoning configuration screen 700 in FIG. 7A.

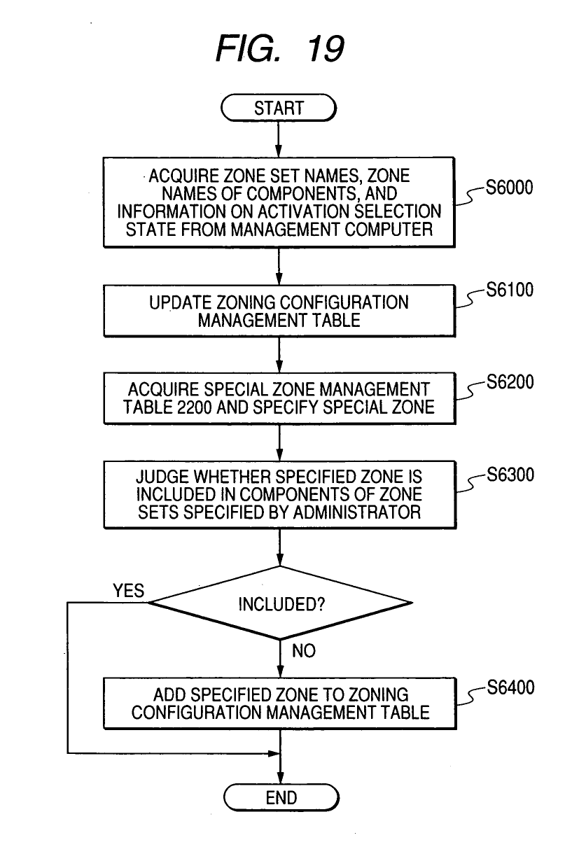

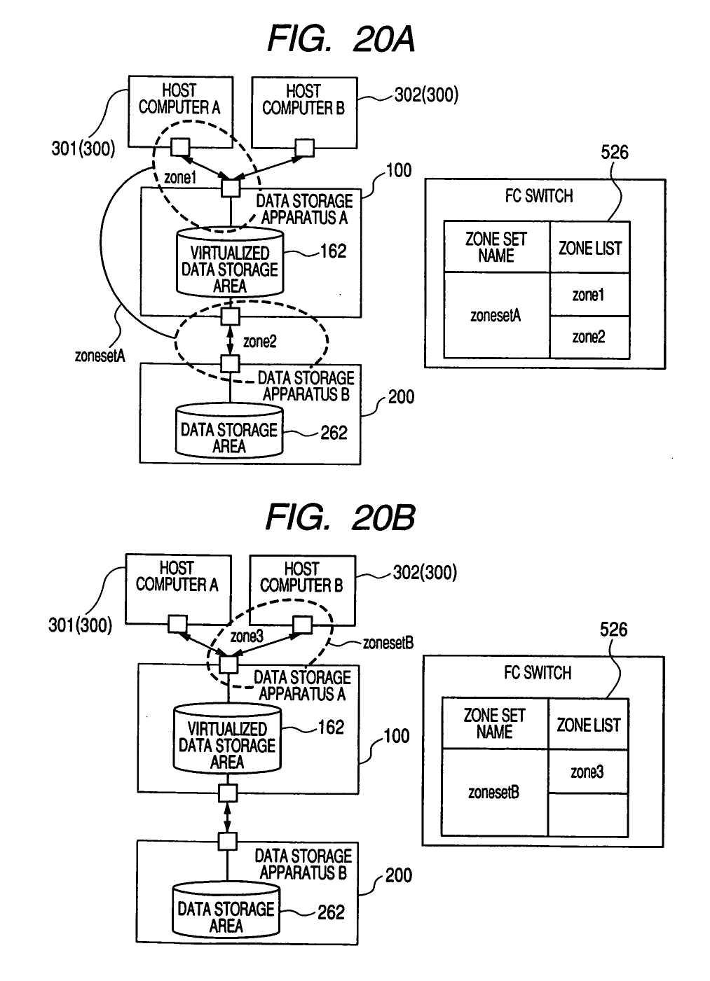

FIG. 19 is a diagram showing a processing flow of the zone activation program 2250 that is executed by the CPU 510. When a zoning configuration setting request from the management computer 400 is received, the CPU 510 acquires a zone set name, zone names of the zone set, and activation selection information from the zoning configuration setting request (step S6000). Then, the CPU 510 updates the zoning configuration table 526 on the basis of the acquired information (step S6100). Next, the CPU 510 acquires the special zone management table 422 and specifies a zone with a special zone configuration flag set to “1” (S6200). The CPU 510 judges whether the zone specified in step S6200 is included in a zone set designated by an administrator (step S6300). As a result of the judgment, if the zone specified in step S6200 is included in the zone set designated by the administrator, the CPU 510 ends the processing. If the zone specified in step S6200 is not included in the zone set designated by the administrator, the CPU 510 additionally adds the zone specified in step S6200 in the zoning configuration table (step S6400).

Note that a data storage apparatus may judge presence or absence of a special zone with reference to a special zone management table 2220 of an FC switch and sends a configuration instruction to the switch such that the special zone is included in a zone set. Alternatively, it is also possible that a data storage apparatus A informs the FC switch of a correspondence relation between a virtualized data storage area, which is provided to a host computer, and an actual data storage area, which stores data used by the host computer, and a name of an FC port assigned to the virtualized data storage area and the informed FC switch executes the zone set activation program by storage hierarchy in the second embodiment.

What is claimed is:

1. An access management method in a management computer that manages: a host computer; a storage system that has an actual data storage area storing data used by the host computer; a first device that is associated with the actual data storage area and provides the host computer with a virtualized data storage area, and a fabric that is connected to any one of the host computer, the first device, and the storage system via a communication path, the access management method comprising:
defining a first access permission path including a path between the host computer and the first device via the fabric and a second access permission path including a path between the first device and the storage system via the fabric, and
when the first access permission path is set in the fabric, setting the first access permission path in the fabric in association with the second access permission path.

2. An access management method according to claim 1, wherein
the host computer has a host computer network interface connected to a network,
the first device has at least one device network interface connected to the network,
the storage system has at least one storage interface connected to the network,
the first access permission path is an access permission path between the host computer network interface of the host computer and the device network interface of the first device,
the second access permission path is an access permission path between the second device network interface and the storage network interface of the storage system, and
the management computer judges whether the second access permission path is set together with the first access permission path on the basis of an correspondence relation between the virtualized data storage area and the actual data storage area, a correspondence relation between the virtualized data storage area and the second device network interface, and a correspondence relation between the storage interface and the actual data storage area.

3. An access management method according to claim 2, wherein
the host computer network interface, the device network interface, and the storage network interface are device ports,
the fabric includes at least one switch,
the switch has plural switch ports connected to the device ports via a communication line and controls data communication among the switch ports according to a zone configuration,
each of the access permission paths includes the zone, and
when the second access permission path is associated with the first access permission path and set in the fabric, the management computer activates a zone set, which includes a zone belonging to the first access permission path and a zone belonging to the second access permission path, in the fabric.

4. An access management method according to claim 3, wherein the zone is constituted by a combination of port identifiers specifying the switch ports.

5. An access management method according to claim 3, wherein the zone is constituted by a combination of World Wide Names of device ports connected to the switch ports.

6. An access management method according to claim 1, wherein the device is a storage system.

7. An access management method according to claim 1, wherein
the management computer specifies the second access permission path, which is an access permission path including the storage system that has the actual data storage area storing the data used by the host computer, as a specific access permission path, and
when the first access permission path including the host computer is set, the first access permission path is set in association with the specific access permission path.

8. An access management method according to claim 1, wherein
the first access permission path is an access permission path between the host computer and the virtualized data storage area,
the second access permission path is an access permission path between the virtualized data storage area and the actual data storage area, and
when the first access permission path and the second access permission path have the same virtualized data storage area each, the management computer sets the first access permission path in association with the second access permission path in the fabric.

9. A computer system comprising:
a host computer;
a second-tier storage system that has an actual data storage area storing data used by the host computer;
a first-tier storage system that provides the host computer with a virtualized data storage area associated with the actual data storage area;
a switch connected to the host computer, the first-tier storage system, and the second-tier storage system via a communication path; and
a management computer connected to the host computer, the first-tier storage system, the second-tier storage system, and the switch via a network, wherein
the switch has plural ports connected to the host computer, the first-tier storage system, and the second-tier storage system, respectively,
the management computer includes:
a memory that holds configuration information of plural zones permitting communication in the computer system via at least one port provided in the switch; and
a control unit that, when any one of the zones is a first zone permitting communication between the host computer and a virtualized data storage area provided to the host computer, extracts a second zone permitting communication with an actual data storage area associated with the virtualized data storage area from the memory and instructs the switch to configure the second zone in association with the first zone via a network.

10. A computer system according to claim 9, wherein
the switch has a first port connected to the host computer via a communication path, a second port and a third port that are connected to the first-tier storage system via a communication path, and a fourth port that is connected to the second-tier storage system via a communication path,
the first-tier storage system holds an association of a port of the first-tier storage system connected to the third port, the virtualized data storage area and an association of the virtualized data storage area and the actual data storage area,
the second-tier storage system holds an association of a port of the second-tier storage system connected to the fourth port and the actual data storage area, and
the control unit provided in the management computer performs control for acquiring each of the associations from the first-tier storage system and the second-tier storage system via the network, extracting a second zone associated with the first zone from the acquired associations, and holding the extracted second zone in the memory as a special zone.

11. A computer system according to claim 10, wherein
the special zone is the second zone, and
when communication control according to the first zone is activated-, the control unit of the management computer instructs the switch to configure the special zone in association with the first zone.

12. A computer system according to claim 10, wherein
when the first zone is a zone including permission of communication with the actual data storage area associated with the virtualized data storage area, the special zone associated with the first zone is not present.

13. A computer system according to claim 11, wherein
the management computer defines a zone set including the first zone and the special zone as members and instructs the switch to activate the zone set via the network.

14. A computer system according to claim 10, wherein
the first-tier storage system includes an actual storage area storing data used by the computer and holds an association of a port of the first-tier storage system and the actual storage area,
the memory of the management computer holds configuration information of a third zone that permits communication between the host computer and the actual data storage area, and
the control unit of the management computer acquires the association of the port of the first-tier storage system and the actual data storage area via the network and, when communication control according to any one of zones defined by the configuration information of zones held on the memory is activated, the first-tier storage system judges whether it is necessary to transmit the read or write request received from the computer system to the second-tier storage system on the basis of the zone configuration information and the association of the port of the first-tier storage system and the actual data storage area and, when it is judged that it is not necessary, instructs the switch to configure the third zone via the network without associating the third zone with other zones and without holding a special zone associated with the third zone in the memory.

15. A computer system according to claim 9, wherein, when the memory does not have the second zone associated with the first zone, the control unit of the management computer defines a second zone having at least a port not belonging to the first zone of the first-tier storage system associated with the virtualized data storage area as a member from a correspondence relation between the virtualized data storage area and the actual data storage area, a correspondence relation between the port not belonging to the first zone, of the first-tier storage system and the virtualized data storage area, and a correspondence relation between the port of the second-tier storage system and the actual data storage area and holds the defined second zone in the memory as a special zone.

16. A switch comprising:
plural switch ports connected to a host computer and plural devices via a communication path;
a memory that holds zone configuration information that defines zones permitting communication including at least one of a path between plural devices or a path between the host computer and the devices; and
a CPU that is connected to the memory and the switch ports, wherein
the CPU reads out the zone configuration information from the memory, holds a first zone, which includes a switch port connected to a first device receiving a request from a host computer and a switch port connected to a second device storing the data, as a special zone among the zones defined by the zone configuration information, configures a second zone defined by a zone including the switch port connected to the first device in association with the first zone serving as the special zone, and permits communication among the switch ports.

17. A switch according to claim 16, wherein
the management computer has a host computer port connected to the communication path,
the devices have device ports connected to the communication path,
the zone configuration information is a combination including at least one of a combination of a name of the host computer port permitted to communicate and the device ports or a combination of the plural device ports, and
the CPU defines a zone set having the first zone serving as the special zone and the second zone as members and holds the zone set in the memory.

18. A switch according to claim 17, wherein
the first device is a virtualized device that provides a virtualized data storage area recognizable by the host computer,
the second device is a storage device that includes an actual data storage area that corresponds to the virtualized data storage area and stores data used by the host computer, and
device ports held by virtualized devices included in the first zone and the second zone are associated with the virtualized data storage area.

19. A switch according to claim 17, wherein the special zone has names of the device ports, which are held by the first device and the second device, respectively, as zone members.

20. A switch according to claim 18, wherein the virtualized device includes an external device port, which sends a request to read out data from and write data in the storage device to the outside according to a request from the host computer, and holds a zone including the external port in the memory as a special zone.
